(19) United States
(12) Patent Application Publication
(10) Pub. No.: US 2026/0307361 A1
(43) Pub. Date: Oct. 8, 2026

(54) RECYCLED SHELL THREE LAYER FABRIC

(71) Applicant: Long Wharf Supply LLC, Seabrook, NH (US)

(72) Inventor: Michael C. Lamagna, Seabrook, NH (US)

(73) Assignee: Long Wharf Supply LLC, Seabrook, NH (US)

(21) Appl. No.: 19/637,425

(22) Filed: Apr. 2, 2026

Related U.S. Application Data
(60) Provisional application No. 63/782,366, filed on Apr. 2, 2025.

(51) Int. Cl. B32B 5/26

(52) U.S. Cl. CPC B32B 5/26; B32B 2250/03; B32B 2250/20; B32B 2255/02; B32B 2262/0292; B32B 2307/584; B32B 2307/718; B32B 2307/7265; B32B 2437/00

(57) ABSTRACT

An article formed from three layers of material and a method of making the same. The article includes an outermost layer constructed of a material such as polyester. A middle layer forms a membrane against the outside elements. The middle layer can be constructed of two materials, one of which is a shell material, and the other of which is polyurethane. In some instances, the middle layer can be 5-25% shell material with the remaining being polyurethane. The innermost layer of the article can be constructed of recycled polyester, nylon, cotton, fleece, wool, terry cloth, or the like.

### CROSS-REFERENCE TO RELATED APPLICATIONS

This application claims priority to and the benefit of U.S. Provisional Patent Application No. 63/782,366, filed on Apr. 2, 2025, the entire contents of which is incorporated herein by reference.

### FIELD OF THE TECHNOLOGY

The subject disclosure relates to multi-layer textile materials and, more particularly, to articles incorporating recycled material.

### BACKGROUND OF THE TECHNOLOGY

For centuries, mariners have often relied on foul weather gear and garments to keep them on the water in inclement conditions. Whether it is rain, wind, snow, sleet, or ocean spray, there is an unending list of various conditions fishermen, boaters, and recreational watermen will face day in and day out. As garments and foul weather gear have developed over time, we have come to appreciate garments that stand up to these elements, serving a reliable functional purpose while remaining comfortable. However, there is still a need for improvement in the garments, gear, and accessories (e.g. duffel bags, tote bags, backpacks, etc.) utilized by mariners on a day-to-day basis.

Separately, food waste is a problem across many different foods types, including in the seafood industry. Seafood restaurants generate millions of pounds of shell waste every year. With no easy way to use to use them, the shells are discarded into landfills. This leads to issues surrounding climate change, toxic leaks, and other environmental challenges.

Thus, there is a need for both suitable garment solutions in the fishing industry and solutions for reducing shell waste.

### SUMMARY OF THE TECHNOLOGY

The subject technology provides a solution at the intersection of the problems discussed above-an article or garment implementing a functionally protective layer of recycled shell. This ensures that less shell ends up in landfills over time and provides functional performance suitable for demanding marine and outdoor environments. In one aspect, a three layer fabric is provided that includes a first outer layer of fabric, a second middle layer that serves as a weatherproof membrane constructed from a blend of recycled shell and polyurethane, and a third inside liner layer of fabric. The weatherproof membrane in the three layer fabric renders a garment made from the fabric functionally waterproof and windproof, providing maximum protection against the elements while still being very lightweight and versatile to pack during travel.

In some embodiments, the recycled shell comprises recycled lobster shell, and the middle layer is a light membrane that comprises recycled lobster shell and polyurethane (PU) to provide a waterproof/weatherproof membrane that adds a technical level of protection outdoors against rain, wind, and other elements encountered on a boat or by the sea. The composition of this layer can vary from 5% to 25% recycled lobster shell with the remaining amount polyurethane, or outside these ranges depending on the weight of the garment desired.

In certain embodiments, the face or outer layer of the fabric serves as the face of the garment and is durable and protects against scratches, scrapes, abrasion, and other potential hazards during general wear. This outer layer can be made of recycled polyester, nylon, polyurethane (PU), cotton, or any combination of these materials blended, and recycled polyester has worked well for first prototypes. The outer layer is often finished with a durable water repellent finish to help water bead off and can be either refinished over time or reactivated by cleaning the cloth.

In some embodiments, the inside liner layer of the fabric provides a comfortable hand feel against skin or on top of other garments worn underneath a jacket or other type of garment made with this textile. In various embodiments this inside layer is made of recycled polyester, nylon, cotton, fleece, wool, terry cloth, or any combinations of these materials blended. These functional materials provide breathability with various layers letting air in while keeping weather conditions out.

In various embodiments, the recycled lobster shell three layer fabric weighs between 100 gsm and 300, or in some cases, substantially 200 gsm, to provide protection during cold seasons, but is also light enough to be worn during warm months.

The textile is versatile and can be used across other categories such as weatherproof duffle bags, backpacks, or other soft goods that are functional under adverse weather conditions, but are still light enough to be able to store away or pack and travel easily.

Other advantages will be evident from the detailed disclosure herein.

### BRIEF DESCRIPTION OF THE DRAWINGS

So that those having ordinary skill in the art to which the disclosed system pertains will more readily understand how to make and use the same, reference may be had to the following drawings.

FIG. 1 is an exploded view of a block diagram of an exemplary three layer material for an article in accordance with the subject technology.

FIG. 2 is a block diagram showing the material of FIG. 1 assembled.

FIG. 3 is a flowchart showing a process of creating a material in accordance with the subject technology.

### DETAILED DESCRIPTION

The subject disclosure provides an effective material for articles being used in difficult environmental conditions while utilizing recycled materials. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper,” “lower,” “distal,” and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e., where an “upper” part must always at a higher elevation).

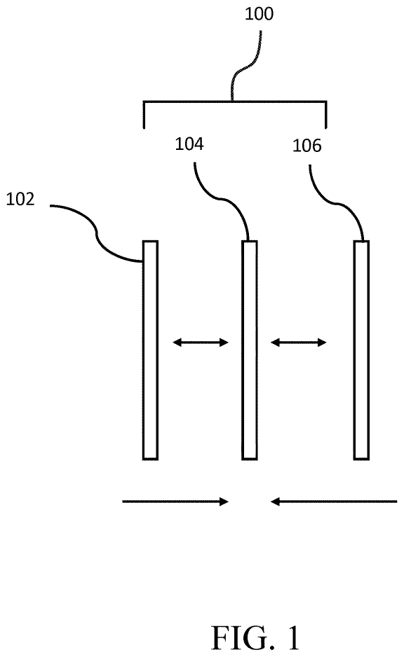

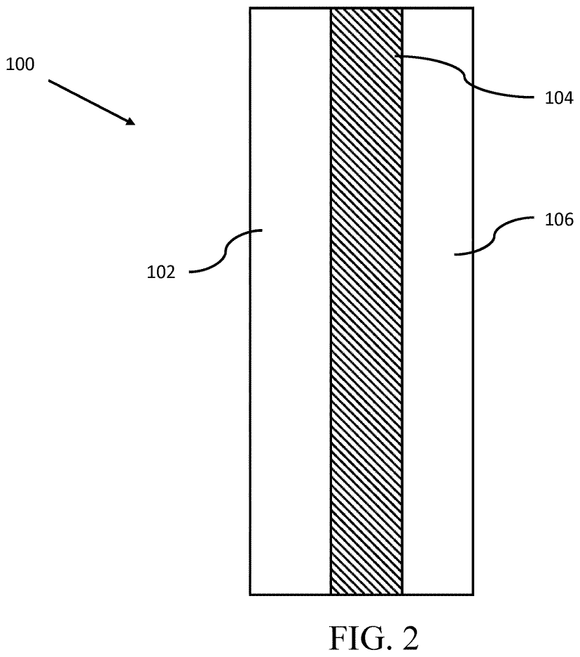

Referring now to FIGS. 1-2, a three layered material 100 in accordance with the subject technology is shown, which can be implemented as part of a garment or other article or accessory. FIG. 1 shows an exploded view of the three layered fabric while FIG. 2 shows the material 100 combined together as it would be used as part of a garment or article.

In various embodiments, the three layered material 100 utilizes a middle layer 104 formed from a combination of recycled shell and polyurethane to render the fabric weatherproof and optimal for outdoor use and travel. In some embodiments, the recycled shell comprises recycled lobster shell obtained from restaurants and food processing facilities where lobster shell would otherwise be discarded. Generally, the three layered material 100 is designed for use in foul weather gear and other articles of clothing used by fishermen, boaters, and recreational watermen who routinely face rain, wind, snow, sleet, and ocean spray. A garment utilizing the material 100 will be protective, functional, and comfortable in such environments. The three layered material 100 described herein can be used as part of a jacket, sweater, hoodie, or shirt, by way of example. Further, while the three layered material 100 is generally described as used within a garment herein, it should be understood that it may be used in articles and/or accessories beyond just clothing, such as bags or backpacks that may be used in harsh weather conditions.

An outer layer 102 serves as the outer face of the material 100 and is the initial shield against the elements. The outer layer 102 is durable and protects against scratches, scrapes, abrasion, and other potential hazards during general wear. The outer layer 102 can be made of recycled polyester, nylon, polyurethane (PU), cotton, or any combination of these materials blended. Recycled polyester has been found to work particularly well for carrying out the goals of the material 100. The outer layer 102 can also be finished with durable water repellent finish to help water bead off. For example, in some embodiments, the durable water repellent can include fluorocarbons or silicone, hydrocarbon, or a wax-based solution.

The outer layer 102 can then be refinished with new finish over time or reactivated by cleaning.

The middle layer 104 is fixed between the outer layer and the inner layer 106, creating a membrane in between. This provides a waterproof and/or weatherproof layer that reinforces the protection provided by the outer layer 102 and prevents the elements such as rain, wind, or other elements typically faced on a boat or by sea, from penetrating into the inner layer 106. The weatherproof membrane renders the material 100 functionally waterproof and windproof, providing maximum protection against the elements while still being very lightweight and versatile to pack during travel. The combination of layers provides breathability, with the layers allowing air in while keeping weather conditions out.

The middle layer 104 can be constructed from combination of shell material and PU. In some instances, the middle layer 104 is between 5%-25% recycled shell material which provides an advantageous blend of being functionally effective while remaining light and not cumbersome. The recycled shell material may come from various sea creatures in different embodiments. For example, in various embodiments, the shell may be a lobster shell, oyster shell, crab shell, mussel shell, or shell from other bivalves. In some exemplary embodiments, lobster shell has been found to be particularly effective, including when combined with polyurethane as described. Any part of the layer 104 that is not recycled shell material is polyurethane. In certain circumstances, a lowered percentage of recycled shell, such as 5-10% recycled shell, may be used.

The inner layer 106 is the innermost layer of material. The inner layer 106 is designed to be comfortable as it may contact a user's skin, or an underlying garment of the type typically worn under a heavier jacket. The inner layer 106 can be made of recycled polyester, nylon, cotton, fleece, wool, terry cloth, or any combinations of these materials blended. In some instances, a combination of lobster shell, polyurethane, and polyester has been found to be particularly effective. In other embodiments, nylon has been found to be particularly advantageous.

In some embodiments, the material 100 can be designed as part of a coat, or other garment to be worn around the torso of a user. The garment can weight between 100 gsm and 300 gsm. For example, in some instances the material 100 weighs substantially 200 gsm (e.g. between 180-220 gsm) to provide protection during cold seasons while still being light enough to be worn during warm months. Generally, outerwear or accessories using this material 100 fall between 100 gsm and 300 gsm depending on intended use. In alternative embodiments the material 100 is versatile and can also be used across other categories such as weatherproof duffle bags, backpacks, or other soft goods that are functional under adverse weather conditions yet light enough to store away or pack and travel easily.

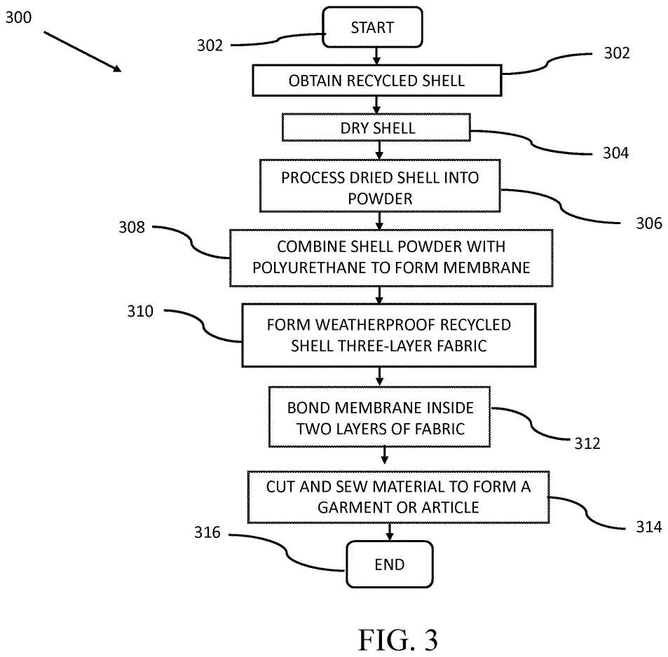

Referring now to FIG. 3, an exemplary method for forming the material 100 for use in a garment or article in accordance with the subject technology is shown generally at 300. At step 302, the process of forming the material starts. Recycled shells are obtained, at step 302. As discussed above, the recycled shells may include, for example, lobster shells, or the shells of other sea creatures as they are being discarded from a restaurant. The recycled shells 302 are then dried out at step 304 and processed into a powder of a smaller size at step 306.

At step 308, the recycled shell powder is then combined with a polyurethane material and mixed with chemicals to bond together and form the membrane, for example, in the ratios discussed herein. For example, standard procedures for creating polyurethane could be used, as are known in the art, which is then bonded with the shell material in an amount described herein. For example, polyurethane can be produced through a chemical reaction between isocyanates and polyols, along with various additives that control performance and processing. The core chemicals can include isocyanates, such as Methylene Diphenyl Diisocyanate and/Toluene Diisocyanate to react with polyols, such as polyether polyols and/or polyester polyols, which control elasticity. The process may also include known additives, including catalysts (e.g., amine catalysts, organotin compounds), blowing agents (e.g., water (produces CO₂), HFCs, pentane), surfactants (e.g. silicone-based), chain extenders and crosslinkers (e.g. ethylene glycol, butanediol), and fillers and flame retardants (e.g. calcium carbonate, phosphate-based flame retardants). The basis rection is isocyanate+polyol→polyurethane (urethane linkage formation).

For example, the bonded material may be 5-25% recycled shell, with the remaining portion being polyurethane. This creates the middle layer. At step 310, inner and outer layers are created, in accordance with the layers described herein. Then, at step 312, the middle layer is bonded inside the outer and inner layers, such that the middle layer forms a waterproof membrane between innermost and outermost layers, preventing the elements from infiltrating to the inner layer. The three layer material has then been formed and can be cut and sewn together to form a finished garment, or other article at step 314. The process ends at step 316.

In some instances, the process 300 can also include adding a waterproof repellant to the outermost layer of fabric, as discussed above. In such instances, the method can also include reactivating the waterproof repellant by cleaning the outermost layer, or reapplying the waterproof repellant after a period of time has passed.

As such, an advantageous three-layered material can be created, which can be utilized as part of a garment or other article. The material provides a lightweight and packable design, which allows a user to remain comfortable and mobile while also staying warm and dry. Since the garment or article uses recycled materials, consumers will often support it over other garments or articles using a virgin material that do not recycle any materials. It should be understood that variations in material type, compositions, and weights within the disclosed ranges can be selected based on whether the three layer material is to be used for outerwear, accessories, or other soft goods. However, the materials and ranges disclosed herein have been found to be particularly advantageous in certain environments of interest.

All references cited herein are incorporated by reference, as though fully set forth herein. All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. An article including three layers of material comprising:
a first layer forming the outermost layer of the article;
a second layer forming a membrane constructed of a first material and a second material, wherein: the first material is between 5-25% of a shell material; and the second material is polyurethane; and
a third layer forming the innermost layer of the article,
wherein the second layer is bonded between the first layer and the third layer to form the membrane therebetween.

2. The article of claim 1, wherein the first layer is a material that is both waterproof and windproof.

3. The article of claim 1, wherein the shell material is recycled lobster shell.

4. The article of claim 1, wherein the first layer is configured to protect against scratches, scrapes, abrasion, and other hazards during general wear.

5. The article of claim 1, wherein the first layer is constructed of one of the following materials: recycled polyester; nylon; polyurethane; or cotton.

6. The article of claim 5, wherein the first layer is recycled polyester.

7. The article of claim 1, wherein the first layer includes a durable water repellent finish, including at least one of the following: fluorocarbons; silicone; hydrocarbon; or a wax-based solution.

8. The article of claim 1, wherein the third layer is constructed of one or more of the following materials: recycled polyester, nylon, cotton, fleece, wool, or terry cloth.

9. The article of claim 1, wherein the article has a weight between 180-220 gsm.

10. The article of claim 1, wherein the second layer is between 5-10% lobster shell, with the rest of the second layer being polyurethane.

11. A method of making a three layer material for an article, comprising:
obtaining recycled shell material;
drying the recycled shell material;
processing the recycled shell material into powder;
forming a middle layer of 5-25% recycled shell material by combining the recycled shell material powder with polyurethane, with the polyurethane being the remaining portion of the middle layer, wherein chemicals are applied to bond the recycled shell material and polyurethane;
forming an innermost layer of the fabric;
forming an outermost layer of the fabric; and
bonding the middle layer between the innermost and outermost layers to form a waterproof membrane.

12. The method of claim 11, further comprising incorporating the three layer material into the article.

13. The method of claim 11, further comprising:
adding a waterproof repellant to the outermost layer of the fabric; and
reactivating the waterproof repellant by cleaning the outermost layer.

14. The method of claim 11, wherein the shell material is recycled lobster shell.

15. The method of claim 11, wherein the innermost layer is constructed of one of the following materials: recycled polyester; nylon; polyurethane; and cotton.

16. The method of claim 11, wherein the outermost layer is constructed of one or more of the following materials: recycled polyester, nylon, cotton, fleece, wool, or terry cloth
17. The method of claim 11, wherein the second layer is between 5-10% lobster shell, with the rest of the second layer being polyurethane.

18. An article including three layers of material comprising:
a first layer forming the outermost layer of the article, the first layer constructed of polyester;
a second layer forming a membrane constructed of a first material and a second material, wherein: the first material is between 5-25% of a shell material; and the second material is polyurethane; and
a third layer forming the innermost layer of the article, wherein the third layer is constructed of one or more of the following materials: recycled polyester, nylon, cotton, fleece, wool, or terry cloth.

19. The article of claim 18, wherein the second layer is between 5-10% lobster shell, with the rest of the second layer being polyurethane.
